(19) United States
(12) Patent Application Publication
(10) Pub. No.: US 2022/0044541 A1
(43) Pub. Date: Feb. 10, 2022

(54) ALARM ARRANGEMENT

(71) Applicant: SONARTEC ALARMS LIMITED, East Oxted, Surrey (GB)

(72) Inventor: John BARSTEAD, Surrey (GB)

(73) Assignee: SONARTEC ALARMS LIMITED, East Oxted, Surrey (GB)

(21) Appl. No.: 17/416,724

(22) PCT Filed: Dec. 19, 2019
(86) PCT No.: PCT/IB2019/061138

§ 371 Date: Jun. 21, 2021

Related U.S. Application Data
(60) Provisional application No. 62/783,893, filed on Dec. 21, 2018.

(51) Int. Cl. G08B 21/08; G08B 21/02; G08B 3/10

(52) U.S. Cl. CPC G08B 21/088; G08B 3/10; G08B 21/0219

(57) ABSTRACT

An alarm arrangement may include a transmitter unit configured to be attached to a user's body. The transmitter unit may have a housing containing operatively connected electronic circuitry components, and water activated electrical contacts outside the housing for causing energization of the electronic circuitry when coming into contact with water so as to emit a chirp operative signal when the transmitter unit enters into water in a water zone being monitored by the alarm arrangement. A receiver unit may have a housing containing operatively connected electronic circuitry components and water activated electrical contacts outside the housing for causing energization of the electronic circuitry when coming into contact with water. The receiver unit may detect an operative signal from the transmitter unit when the transmitter unit comes into contact with water, and the receiver unit may then be configured to emit a suitable alarm signal.

### CROSS REFERENCE TO RELATED APPLICATIONS

This application claims priority to and the benefit of the filing date of U.S. Provisional Application No. 62/783,893, filed on Dec. 21, 2018, entitled “ALARM ARRANGEMENT”, which is hereby incorporated by reference in its entirety.

### FIELD OF THE INVENTION

The present invention relates to an alarm arrangement. More particularly, the present invention relates to an alarm arrangement in particular for use in association with swimming pools.

### BACKGROUND

Children, in particular infants, often fall into swimming pools with fatal consequences. This happens even when parents or other supervisors practically stand next to such children.

Various devices and arrangements have been suggested to avoid such senseless drowning of children. However, these systems often are complicated, very expensive, and some are not effective and suffer from other disadvantages.

U.S. Pat. No. 4,121,200 (Colmenero) discloses a swimming pool alarm system for activating an alarm indicator responsive to the presence of a person in a pool being monitored. The system includes a frequency selective detector responsive to water disturbance created by a person in a swimming pool. The detector enables a transmitter at poolside. A receiver remotely mounted with respect to the poolside transmitter responds to the transmissions therefrom activating the alarm indicator.

U.S. Pat. No. 4,701,751 (Sackett) discloses an alarm system for a swimming pool which comprises the use of a height sensing apparatus employing fibre optics and a logic circuit whereby an interruption of a pair of different elevations of light paths is accepted and the alarm remains silent and the interruption of the lowest light path only is reflected sounding an alarm.

U.S. Pat. No. 5,049,859 (Arnell) discloses a pool safety alarm system which includes a water-activated sonar transmitter adapted to be worn on the body of a non-swimmer for continuously transmitting low frequency audio signals upon immersion of the transmitter. An underwater microphone or hydrophone is located within the pool and is connected to a receiver circuit having a band pass filter connected to a monostable multivibrator for supplying signals to an alarm.

U.S. Pat. No. 5,097,254 (Merrithew) there is described a swimmer protection and pool safety warning device comprising a portable sonic signal generating member worn by a swimmer in a pool, the signal generating member having a switch or similar device which is activated at a predetermined depth.

U.S. Pat. No. 5,144,285 (Gore) discloses a pulsed ultrasonic apparatus for monitoring a swimming pool and which includes a transmitter housing securable to a child and provides a swept frequency pulsed output from a transducer within the housing when an electrical circuit is completed by having a pair of tabs on the outside of the housing immersed in water. The output from the transducer is detected by a receiving hydrophone and the hydrophone is connected to receiver circuitry which provides an appropriate alarm signal.

U.S. Pat. No. 5,274,607 (Bean) discloses a system for continuous echo analysis of a body of liquid, surrounded by walls of known dimension, for the presence of an object.

U.S. Pat. No. 5,369,623 (Zerangue) describes at least one transducer support immersed in a swimming pool. The transducer support has a plurality of transducer means mounted on the support which are capable of sending and receiving acoustic energy.

U.S. Pat. No. 5,486,814 (Quinones) discloses a swimming pool monitoring device which can be attached to a child to constantly transmit an electromagnetic radio wave of a desired frequency. The monitoring device contains a water submersion sensor, which will deactivate the transmitter upon submersion. Whenever transmissions from the monitoring device are interrupted, due to immersion or battery failure, a receiver will sense this condition and activate an alarm, which may be visual, audible, or a signal that is relayed to further remote wireless equipment such as a pager or telephone dialing equipment that is used to dial an emergency telephone number.

U.S. Pat. No. 5,638,048 (Curry) discloses a sonar, lidar, or radar system is disclosed which generates an alarm signal if a child enters a swimming pool when the system is enabled, and includes multiple safeguards against sounding false alarms due to windactivated waves in the pool or self interference arising from multi-path propagation of sonar signals. An acoustic or electromagnetic receiver having a narrow bandwidth is employed to demodulate a composite signal spectrum produced by a target object such as a child and signals generated by wind-activated waves.

U.S. Pat. No. 6,476,721 (Diebold) discloses an alarm arrangement for swimming pools includes an electronic transmitter unit and an electronic receiver unit. The transmitter unit has a housing containing electronic circuitry. Water activated electrical contacts are provided outside the housing for causing energization of the electronic circuitry when coming into contact with water for emitting an ultrasonic operative signal when a person wearing the transmitter unit enters into water in a pool. The receiver unit has a housing containing electronic circuitry, water activated electrical contact outside its housing for causing energization of the electronic circuitry when coming into contact with water, for detecting any preselected operative signal from the transmitter unit when the transmitter unit comes into contact with water in a pool so as to emit a suitable alarm signal. An investigation and range of functional tests evaluated the performance of this system using the acoustic test facilities. The tests on the transmitter which has a frequency range 30-90 kHz illustrated that it provides a directional response and is susceptible to attenuation by bubbles in the pool.

Therefore, a need exists for a novel alarm arrangement, which is relatively simple and economic, and which is capable of protecting children and other users against the dangers of falling into water and of overcoming the aforesaid problems.

### BRIEF SUMMARY OF THE INVENTION

An alarm arrangement for causing an alarm signal to be emitted in response to a person being monitored when entering a water zone is provided. In some embodiments, the alarm arrangement may include at least one transportable electronic transmitter unit and at least one electronic receiver unit, the arrangement being characterized thereby that the transportable electronic transmitter unit has attachment means for associating it with a user's body, and a housing containing operatively connected electronic circuitry components, and having water activated electrical contacts outside the housing for causing energization of the electronic circuitry when coming into contact with water so as to emit a chirp operative signal when such a person wearing the transmitter unit enters into water in a water zone being monitored; and the receiver unit having a housing containing operatively connected electronic circuitry components, and having water activated electrical contacts outside the housing for causing energization of the electronic circuitry when coming into contact with water, and being adapted to detect any operative signal at a preselected frequency from the transmitter unit when the transmitter unit comes into contact with water in the water zone being monitored, and the receiver unit being adapted thereupon to emit a suitable alarm signal.

In some embodiments, the transmitter unit may include an electronic circuit including operatively connected together connection means for connection to a battery, an electronic switch, a crystal stabilized oscillator, an amplifier and a speaker.

In some embodiments, the speaker may be or may comprise a piezoelectric speaker.

In some embodiments, the transmitter unit may be adapted to emit a chirp operative signal in the range of 8 to 12 kHz.

In some embodiments, the receiving unit may include an electronic circuit including operatively connected together connection means for connection to a battery, an electronic switch, a voltage regulator, a voltage comparator, a micro-processor, an active band pass filter, two amplifiers, a phase lock loop, a microphone and a speaker.

In some embodiments, the micro-processor may be adapted by a first step to conduct an initial battery check routine whereby the logic state of the voltage comparator is monitored so as to establish whether or not the battery is sufficiently charged and to cause an appropriate signal to be emitted by the speaker.

In some embodiments, the micro-processor may be adapted as a second step to monitor the logic state of the electronic switch to establish whether or not the switch is closed.

In some embodiments, the electronic switch of the receiver unit may be adapted to close when the electrical contacts located outside of the housing are bridged by way of water, and if not bridged by way of water in a predetermined period of time, to cause an appropriate signal to be emitted by the speaker.

In some embodiments, the micro-processor as a third step may be adapted to monitor signals received by the microphone and on reception of an operative signal having a preselected frequency to generate an appropriate signal which is amplified by the amplifier and conveyed to the speaker for emitting an alarm signal.

In some embodiments, the micro-processor may be adapted to calculate frequencies of all signals received and on reception of a pre-selected frequency to enter into the first monitoring mode whereby an appropriate signal is emitted by the speaker indicating a sufficiently charged battery and thereafter generating an appropriate signal which is amplified by the amplifier and conveyed to the speaker, which generates an audible alarm signal.

In some embodiments, the housing of the transmitter unit may include a base, opposite side walls and a top; the housing defining a first chamber adapted to contain the electronic circuitry components, and further defining a second chamber adapted to removably locate the battery and being closable by way of a threaded nut forming one of the electrical contacts of the transmitter unit.

In some embodiments, the housing of the receiver unit may include a hollow cylindrical body closed at one side by a base and closed at the other side by a lid, which is removably and sealingly attached to the cylindrical body by a threaded ring.

In some embodiments, the housing may trap a volume of air once the lid is attached, the air rendering the housing to be floatable if placed in water in the water zone.

In some embodiments, the receiver piezo configuration may be cylindrical.
In some embodiments, the alarm arrangement may be adapted to not require the need for reliance on a reflected signal and increases the operational distance of the alarm arrangement significantly.

In some embodiments, the receiver unit may house an encoded radio receiver to trigger a remote alarm in the house.

In some embodiments, the alarm arrangement may be adapted to generate a signal of approximately 131 db (i.e. 1 μPa at 1 meter).

In some embodiments, the signal may be detectable to at least a 100 meter range.

In some embodiments, the alarm arrangement may include an ultrasonic transducer to audibly indicate when the battery is low.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts a block diagram of some of the components of an example an alarm arrangement according to various embodiments described herein.

FIG. 2 illustrates a block diagram of some example electronic components of an alarm arrangement as shown in FIG. 1 according to various embodiments described herein.

FIG. 3 shows a circuit diagram of an example of a transmitter unit of the alarm arrangement referred to in FIG. 2 according to various embodiments described herein.

FIG. 4 depicts a circuit diagram of an example of a receiver unit of the alarm arrangement referred to in FIG. 2 according to various embodiments described herein.

FIG. 5 illustrates a side view of an example transmitter unit which may include the components of circuit diagram illustrated in FIG. 3 according to various embodiments described herein.

FIG. 6 shows a plan view of the example transmitter unit of FIG. 5 according to various embodiments described herein.

FIG. 7 depicts a sectional front elevation view of an example receiver unit which may include the components of circuit diagram illustrated in FIG. 4 according to various embodiments described herein.

FIG. 8 illustrates a diagram showing an enlarged partial view of an example of a receiver base of the alarm arrangement according to various embodiments described herein.

FIG. 9 shows the spectrum of the acoustic output of the alarm arrangement according to U.S. Pat. No. 6,476,721 (Diebold).

FIG. 10 depicts the envelope of 8-12 kHz frequency sweep on the transmit transducer of the alarm arrangement according to various embodiments described herein.

FIG. 11 illustrates the envelope of 8-12 kHz frequency sweep with transmit transducer rotated 90° of the alarm arrangement according to various embodiments described herein.

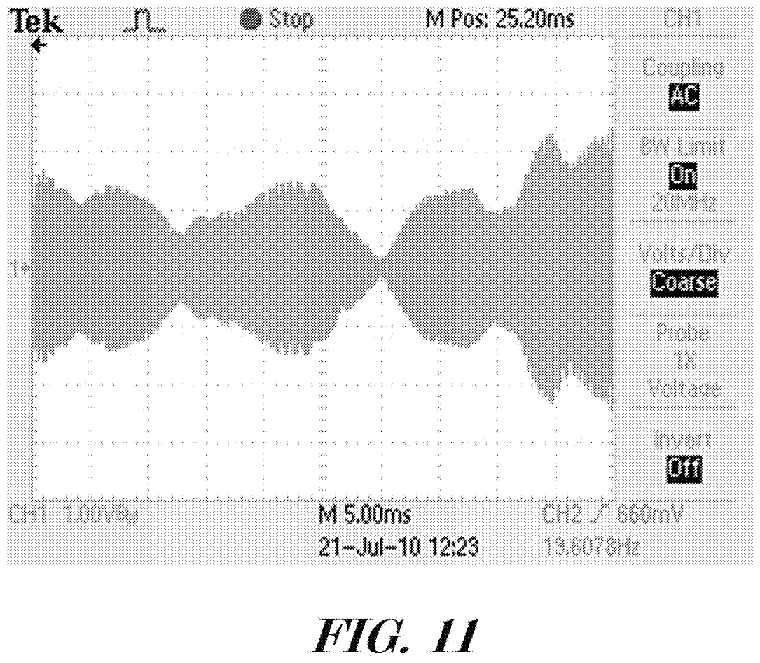

FIG. 12 shows a block diagram of an example receiver structure of the alarm arrangement according to various embodiments described herein.

FIG. 13 depicts ringing observed on transducer in air of the alarm arrangement according to various embodiments described herein.

FIG. 14 illustrates ringing observed on transducer in water of the alarm arrangement according to various embodiments described herein.

### DESCRIPTION OF THE REFERENCED NUMERALS

10 swimming pool
12 water
14 alarm arrangement
16 transmitter unit
18 receiver unit
20 housing
22 battery
24 contact
26 contact
28 electronic switch
30 oscillator
32 amplifier
34 speaker
36 housing
38 switch
40 battery
42 voltage regulator
44 voltage comparator
46 microprocessor
48 amplifier
50 speaker
52 switch
54 contact
56 contact
58 phase lock loop
60 amplifier
62 active band pass filter
64 microphone
66 underside of cylinder
68 connector
70 contact
72 contact
74 contact
76.1 contacts
76.2 contacts
76.3 contacts
78 base
80 side wall
82 side wall
84 curved top
86 chamber
88 chamber
90 opening
92 nut
94 sealing ring
96 slot
98 slot
100 strap
102 bottom cylindrical part
104 floor
106 top cylindrical part
108 open end
110 disc
112 knob
114 sealing ring
116 threaded ring
118 screw thread
120 receiving end
122 plate
124 crystal
126 locator
128 adhesive
130 legs
200 person being monitored

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

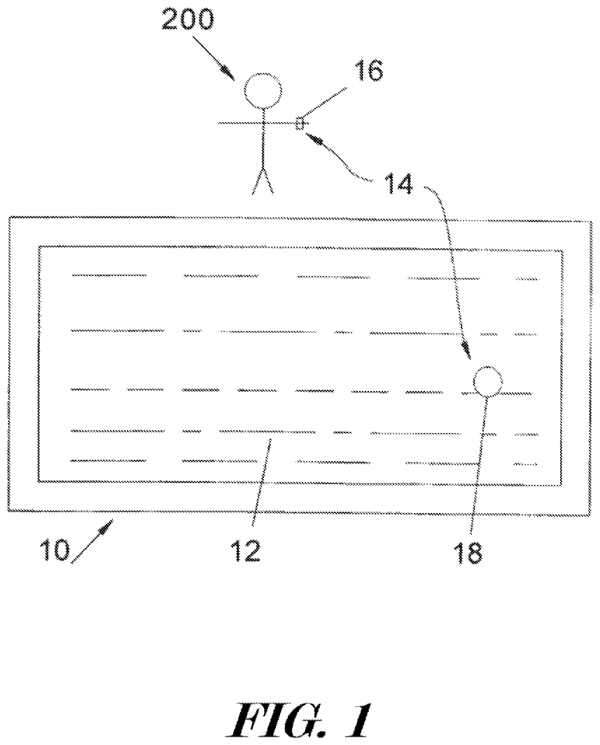

For purposes of description herein, the terms “upper”, “lower”, “left”, “right”, “rear”, “front”, “side”, “vertical”, “horizontal”, and derivatives thereof shall relate to the invention as oriented in FIG. 1. However, one will understand that the invention may assume various alternative orientations and step sequences, except where expressly specified to the contrary. Therefore, the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Although the terms “first”, “second”, etc. are used herein to describe various elements, these elements should not be limited by these terms. These terms are only used to distinguish one element from another element. For example, the first element may be designated as the second element, and the second element may be likewise designated as the first element without departing from the scope of the invention.

As used in this application, the term “about” or “approximately” refers to a range of values within plus or minus 10% of the specified number. Additionally, as used in this application, the term “substantially” means that the actual value is within about 10% of the actual desired value, particularly within about 5% of the actual desired value and especially within about 1% of the actual desired value of any variable, element or limit set forth herein.

A new alarm arrangement is discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

As mentioned above, tests on the known transmitters of the alarm arrangement of U.S. Pat. No. 6,476,721 (Diebold) which has a frequency range 30-90 kHz illustrated that it provides a directional response and is susceptible to attenuation by bubbles in the pool. However, the alarm arrangement of the present invention preferably utilizes a transducer adapted to emit a more effective chirp signal in the 8-12 kHz frequency band. This lower frequency provides better coverage in all directions and better copes with bubbles in the pool. A similar drive circuit to the current version running from the 12V battery generates a signal of about 131 db and this is detectable at a distance of at least a 100 meters range.

A further test has proved that the RCID recommended receiver microcontroller ‘ATmega48PA’ can implement a matched filter detector within the power budget of the receiver unit. Chirp detection software code was executed on the microcontroller and it reliably detected the chirp signal transmitted from a signal generator. The ATmega48PA microcontroller proved that it would be possible for its power consumption to be 3 mW, or less if the operating voltage was reduced below 2.4 Vdc. This compares well against the known designs which used a battery pack (4×alkaline D cells) with an average 4.1 mW power consumption for a 3 year operating life span.

In FIG. 1 a swimming pool 10 is indicated in which water 12 is contained. (It must be noted that the swimming pool 10 may be any water containing zone.)

In some embodiments, an alarm arrangement, generally indicated by reference numeral 14, includes a transmitter unit 16, may include a strap 100, such as a waist belt, arm bracelet or ankle bracelet adapted to be worn by a person such as a child, and at least one receiver unit 18 located strategically in or around the swimming pool 10. In the drawing the receiver unit 18 is shown to be located floatingly on or in the water 12 of the swimming pool 10.

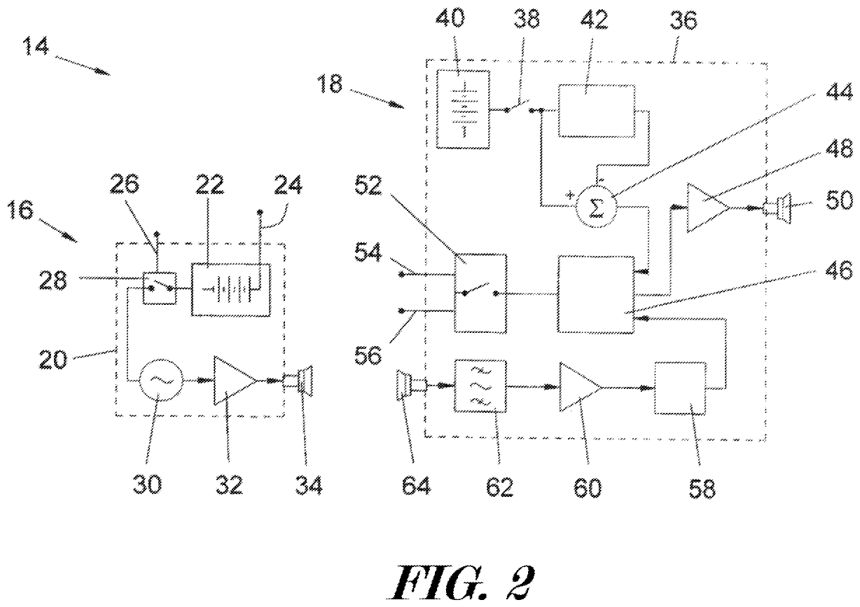

Referring to FIG. 2, a block diagram of various example components of an alarm arrangement 14 is illustrated.

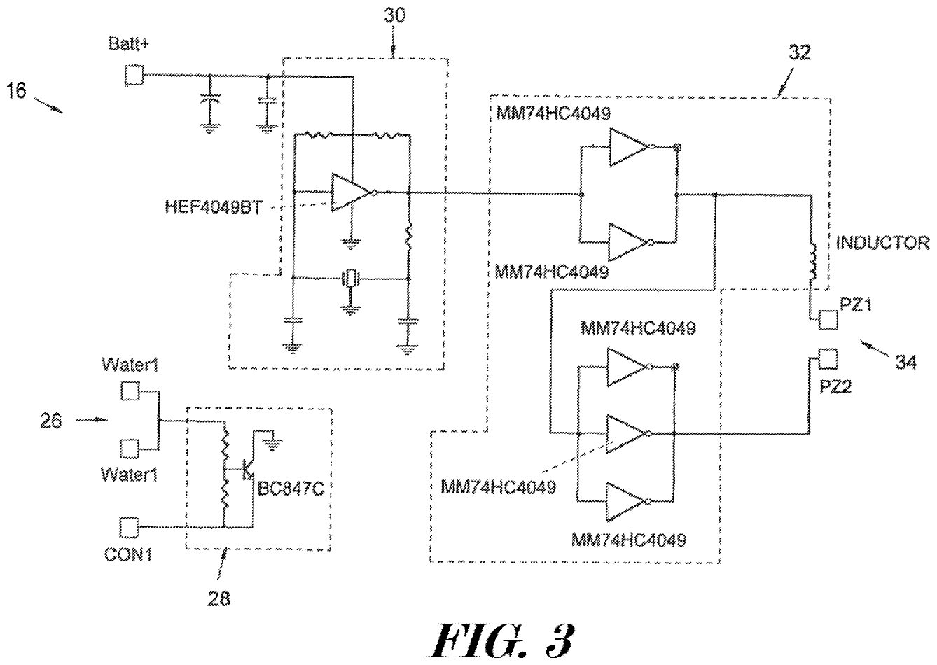

The transmitter unit 16 is encased in a water tight housing 20, in which there is provided a battery 22 and two contacts 24, 26, which are exposed on the outside of the housing 20. The contact 24 is connected to the positive side of the battery 22. Further there are connected in series to the battery 22, an electronic switch 28, a crystal stabilized oscillator 30, an amplifier 32 and a speaker 34, such as a piezoelectric speaker. An example of various electronic components and the interconnection thereof of a transmitter unit 16 are shown in detail in FIG. 3.

When the transmitter unit 16 is outside or not in contact with the water 12 of the swimming pool 10, an electrical resistance created by the ambient air exists between the contacts 24, 26. This electrical resistance is extremely large. On the other hand, when a user, such as a person being monitored 200, wearing the transmitter unit 16 falls or enters into the swimming pool 10, the transmitter unit 16 is submerged in the water 12. Thereby water is present between the contacts 24, 26 and the electrical resistance between these contacts is reduced. This lower resistance causes current to flow so as to activate the electronic switch 28, which allows the battery 22 to energize the oscillator 30 and the amplifier 32. The output of the amplifier 32 causes the speaker 34 to vibrate at a certain crystal frequency, and a signal is created in the water 12 of the swimming pool 10.

Preferably, he signal emitted by the speaker 34 is a chirp operative signal in the range of approximately 8-12 kHz.

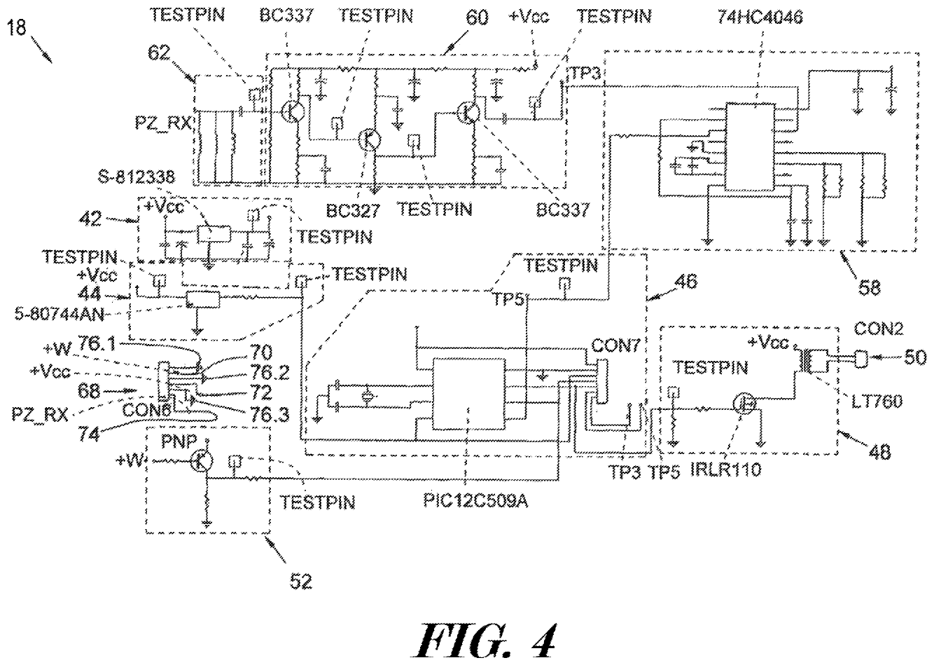

Reference now will be made to the receiver unit 18, of which an example electronic circuit diagram is shown in FIG. 4. The receiver unit 18 is encased in a water tight housing 36 and floats in the swimming pool 10.

By opening the housing 36, a slide switch 38 can be accessed in order to activate the receiver unit 18. This allows power to be supplied from a battery 40 to other internal circuitry of the receiver unit 18. However, the slide switch 38 also can be omitted so that when a battery or batteries are connected, then the receiver unit 18 is energized.

The internal circuitry of the receiver unit 18 includes a voltage regulator 42, which is connected to the battery 40 and a voltage comparator 44. The voltage comparator 44 is further connected to a microprocessor 46.

After activation, the microprocessor 46 enters an initial battery check routine or first monitoring mode whereby it monitors the logic state of the voltage comparator 44. If the voltage of the battery 40 is above a reference voltage, the microprocessor 46 generates a signal which is amplified by an amplifier 48 and conveyed to a speaker 50 which generates an audible tone indicating to a user that the battery 40 is still good. Alternatively, a light (e.g. an LED diode) may be included in the circuitry and may be mounted visibly on the housing 36 to indicate that a battery of sufficient strength is included in the circuitry. Thus, a person can observe at a distance from the receiver unit 18 whether or not the receiver unit 18 is in operative condition.

After this first monitoring mode, the microprocessor 46 preferably has a thirty second or other time delay, allowing the user first to close the housing 36 and then to place the receiver unit 18 in the water 12.

On expiration of the thirty second or other time delay, the microprocessor 46 enters a second monitoring mode where it monitors the logic state of an electronic switch 52, which is connected to two contacts 54, 56 that extend beyond and are exposed outside the housing 36. If the contacts 54, 56 are submerged in water, the electrical resistance between them is relatively low, causing the electronic switch 52 to close.

The microprocessor 46 is further connected in series to a phase lock loop 58, an amplifier 60, an active band pass filter 62 and a microphone 64. The microphone 64 is located in the housing 36 such that it can detect any signals which may exist in the water 12.

Once the switch 52 has closed, the microprocessor 46 enters a third monitoring mode whereby it monitors all signals detected by the microphone 64. This is the normal operating condition for the receiver unit 18. No alarm will sound unless an appropriate operative signal is received from the transmitter unit 16.

If the receiver unit 18 is not placed into the water 12 before the expiration of the thirty second time delay, the microprocessor 46 will generate a signal which is amplified by the amplifier 48 and conveyed to the speaker 50, which generates an appropriate (audible) tone, indicating that the receiver unit 18 is out of the water 12.

When both the transmitter unit 16 and the receiver unit 18 are activated, the signal emitted by speaker 34 in the water 12 is picked up by the microphone 64. The signal is passed through the active band pass filter 62, which limits the received signal bandwidth to improve the signal-to-noise ratio. The output from the filter 62 is amplified by the amplifier 60 and applied to the phase lock loop 58, which will only lock onto signals within a very narrow bandwidth of the frequency of the signal emitted by the transmitter 16. The output of the phase locked loop 58 is monitored by the microprocessor 46, which is programmed as a frequency counter. The microprocessor 46 will calculate the frequency of all the signals it receives and as soon as it receives a correct or preselected frequency, it firstly enters the first monitoring mode whereby it causes the sounding of the appropriate tone by the speaker 50 to indicate whether the battery is still good. Thereafter, the microprocessor 46 generates a signal, which is amplified by the amplifier 48 and conveyed to the speaker 50, which then generates an audible alarm tone. The alarm will sound for as long as an acoustic signal is received by the microphone 64 from the transmitter 16. The alarm signal can be continuous or intermittent.

This means that if a child or other person or even animal wearing a transmitter unit 16 falls into the water 12 of the swimming pool 10, a chirp operative signal emitted by the speaker 34 is picked up by the microphone 64, which results in an alarm signal to be emitted by the speaker 50. Any person around the pool 10 thereby is notified that a wearer of a transmitter 16 is in the water 12 and may be in need of help.

When it is necessary to switch off the receiver unit 18, it is taken out of the water 12. As the contacts 54, 56 are now outside the water 12, the electronic switch 52 opens and the microprocessor 46 enters the first monitoring mode. Thereafter the microprocessor 46 enters a thirty second or other time delay whereafter it will generate an alarm tone indicating that the receiver unit 18 is out of the water 12. This thirty second or other time delay allows the user enough time to open the housing 36 and switch of the switch 38.

If a user wishes to test whether the batteries 22, 40 still supply satisfactory power, the user can do so preferably by using two methods.

According to the first method, if only the battery 40 of the receiver unit 18 is to be tested, the user can simply lift the receiver unit 18 out of the water 12. As explained above, this causes the microprocessor to enter the first monitoring mode, thereby sounding an audible tone if the battery 40 is satisfactory.

According to the second method, if both batteries 22, 40 are to be tested, the user can place the transmitter 14 into the water 12. As explained above, this causes the microprocessor to enter the first monitoring mode, thereby sounding an appropriate audible tone if the battery 40 is satisfactory. The user can then remove the transmitter 14 from the water 12 before the alarm signal is generated. This will automatically also test whether the battery 22 is satisfactory, and if it is not satisfactory, no acoustic signal will be generated in the water 12 and no audible tone will sound.

More than one transmitter 16 can be used at the same time in connection with a single receiver unit 18.

The microphone 64 conveniently is provided at the underside 66 of the housing 36 to ensure that proper water contact is made allowing the microphone 64 to pick up signals emitted by the transmitter 16.

As is shown in FIG. 4, a connector 68 is provided with contacts 70, 72, 74, 76.1, 76.2, 76.3. Contact 70 is coupled to the one exposed water contact 54. Contact 76.1 is coupled to the other exposed water contact 56. Contact 70 is coupled to the positive terminal of the battery or batteries 40. Contact 76.2 is coupled to the negative terminal of the battery or batteries 40. Contact 74 is coupled to the one terminal of the microphone 64. Contact 76.3 is coupled to the other terminal of the microphone 64.

Conveniently the crystal oscillator 30 oscillates at a frequency of 8-12 KHz.

The phase locked loop 58 locks onto any signal within a band width of about 15 kHz central around 10 kHz, being the frequency of the transmitter unit 16.

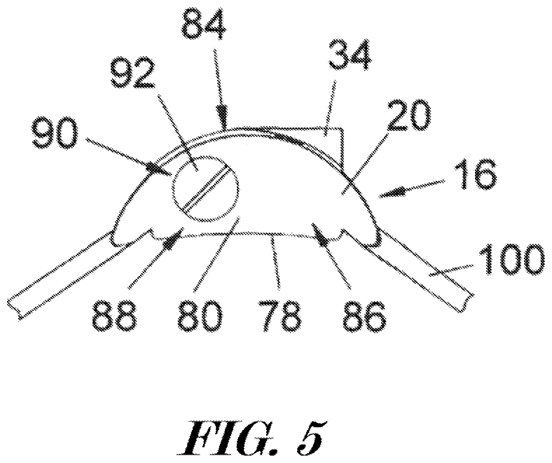

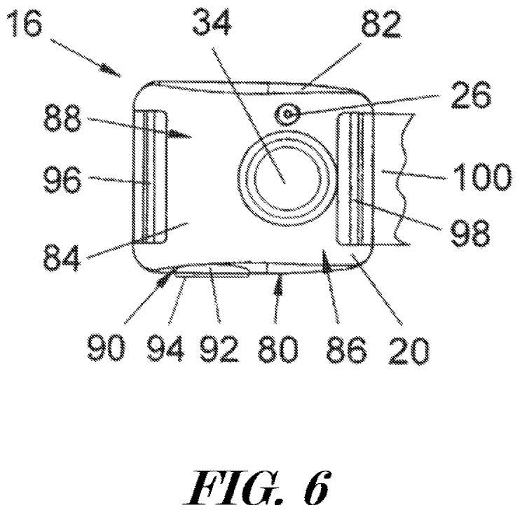

In FIGS. 5 and 6 details of an example transmitter unit 16 and its housing 20 are shown. Preferably, the housing 20 has a base 78, side walls 80, 82 and a curved top 84, defining two chambers 86, 88. The chamber 86 receives in watertight manner the electronic circuit of the transmitter unit 16 as illustrated in FIG. 3 so that only the contact 26 protrudes to the outside of the housing 20. The chamber 88 has an opening 90 at one end and receives the battery 22. The opening 90 is sealingly closable by way of a nut 92 (threaded fastener) with a sealing rubber ring 94. The nut 92 constitutes the contact 24.

The housing 20 further has opposite slots 96, 98 in the base 78 receiving a strap 100 for attachment to a person being monitored 200 or user's arm, leg or waist.

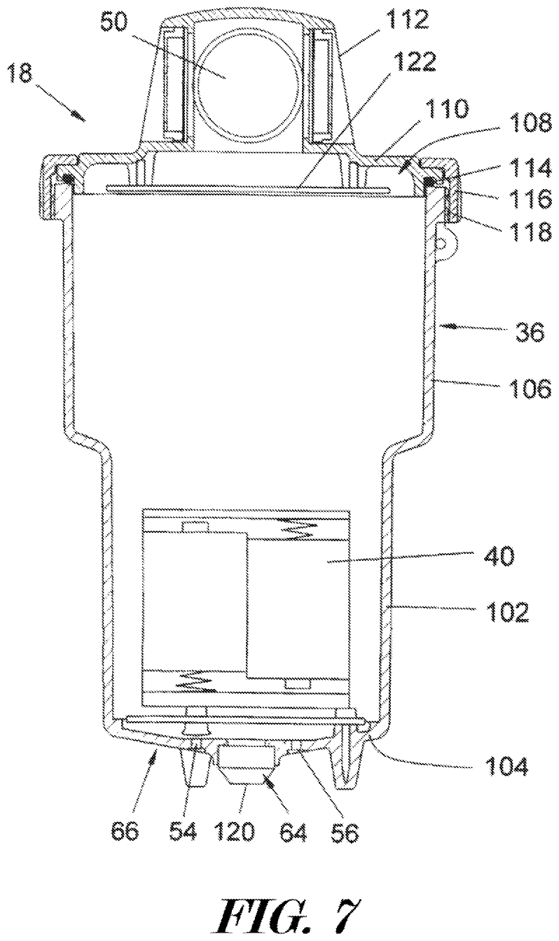

In FIG. 7 details of an example of the receiver unit 18 and its housing 36 are shown.

Preferably, the housing 36 has a bottom cylindrical part 102 with a floor 104, and integrally formed therewith a wider top cylindrical part 106 terminating in an open end 108. The open end 108 is closable by way of a disc 110 carrying a top knob 112 and, on its underside receiving a sealing rubber ring 114 fitting onto the cylinder 106 around the open end 108. The disc 110 is clamped onto the open end 108 by an integrally threaded ring 116 engaging screwingly with an external screw thread 118 at the outer upper end of the cylinder 106. Thereby the housing 36 is sealingly and air tight closed and can float in water.

On the floor 104 the microphone 64 is fitted with its receiving end 120 projecting to the outside to be in good contact with the water. Also, the contacts 54, 56 are located on the outside of the floor 104.

The battery (or batteries) 40 are located in the bottom cylinder 102. The remainder of the electronic circuitry is mounted on a plate 122 fitted to the disc 110.

The knob 112 supports the speaker 50.

The receiver unit 18 and its housing 36 may be configured to float in water so that the bottom cylinder 102 and part of the upper cylinder 106 are submerged in the water.

The alarm arrangement 14 in accordance with the invention therefore provides that easily operable units are used to achieve the intended object. Firstly, there is the receiver unit 18 which is energized by a battery 40 and which floats in water, e.g. a swimming pool. Thus, no connections to the outside are required. Secondly the transmitter unit 16 is contained in a housing 20 which receives a battery 22 and which is attached by way of a strap 100 to a user's body, such as a person being monitored 200.

Should the user or person being monitored 200 fall into the water, after a predetermined delay of, say, 5 seconds, an ear piercing alarm is emitted by the receiver unit 18 to draw attention to the fact that a person has fallen into the water and is in need of help. Furthermore, a single receiver unit 18 can control several transmitter units 16 attached to different users.

Insofar as is possible the various components of the housing 20 of the transmitter unit 16 and the housing 36 of the receiver unit 18 may be made of plastics material by injection molding or any other suitable material.

The transmitter circuit of the transmitter unit 16 includes a microcontroller (such as Atmel ATtiny 25/45) used to generate the chirp signal in the 8-12 kHz frequency band. The transmitter unit 16 is adapted to generate a signal of approximately 131 db (i.e. 1 μPa at 1 meter) from the 12V battery. This is detectable to at least a 100 meter range in water.

The transmitter unit 16 generates a chirp signal to send to the receiver unit 18.

The transmitter unit 16 is adapted to use the ultrasonic transducer to audibly indicate when the battery is low.

The receiver unit 18 uses a microcontroller, such as an Atmel Atmega48PA microcontroller, to detect the chirp signal frequency. It can meet the stringent power requirements necessary to operate over a 3 year lifecycle. The alarm arrangement 14 is further optimized for power consumption by reducing the operating voltage or reducing the duty cycle of the receiver without significant detection delay.

Preferably, the power consumption of the receiver unit 18 is approximately 3 mW. The aim is to achieve 3 years use from a non rechargeable battery source (such as 4×1.5V 18 Ah alkaline D cells).

‘Out of Water’ detection: A simple circuit to detect the envelope of the ringing when the transducer is periodically excited with a short pulse. The frequency at which this measurement is repeated will effect power consumption but a compromise is e.g. checking every 10 secs to see if the circuit is still in the water.

The alarm arrangement 14 includes a writ of a routine to detect a chirp signal sent by the transmitter.

The alarm arrangement 14 preferably includes a single PCB and includes an antenna design protruding out of a dome shaped top.

An accelerometer footprint is included in the PCB design of the alarm arrangement 14 to enable ‘wave detection’ as a motion detection feature.

The two microcontrollers of the alarm arrangement 14 may be from the low power Atmel AVR family; ATtiny 25/45 for the transmitter and ATmega48PA for the receiver. AVR Studio v4.0 is the software development environment with code written in assembly language and high level language ‘C’ using the WinAVR compiler.

The casing of the transmitter unit 16 is adapted to suit the acoustics.

The receiver unit 18 includes an external, waterproof (IP67), 3-position switch is required (Normal, Wave detection and off mode).

The alarm arrangement 14 includes a receiver transducer to detect when the alarm arrangement 14 is submerged. If the transducer, whilst in air is excited by a pulse the oscillations are weakly damped and so continue for a long period compared to when the transducer is in water, where most of the energy of the oscillations escape into the water.

Preferably, the receiver unit 18 has new dome shaped top for the PCB antenna to protrude. It may have a large diameter and a tall top to fit the PCB vertically (including printed aerial) above the sounder sensors.

The alarm arrangement 14 preferably includes either mooring or tethering of the receiver unit 18 in the pool by weights or suckers.

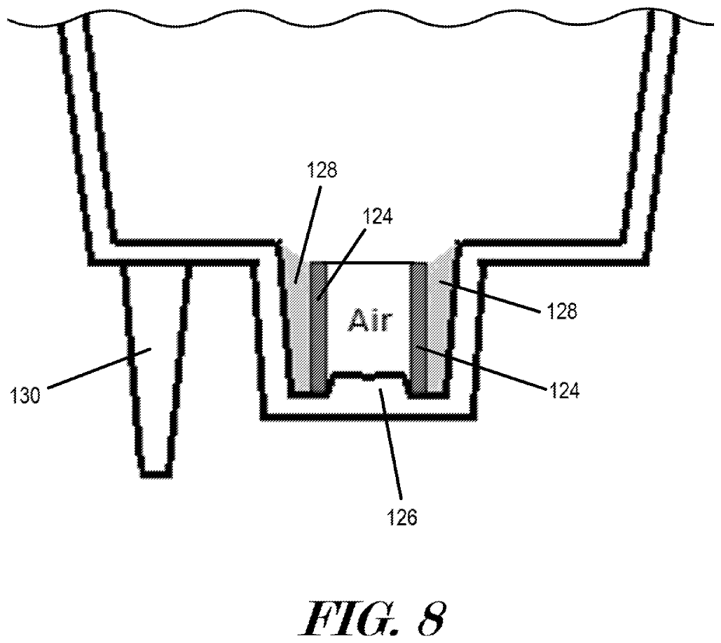

The crystal is cylindrical, fully enclosed with a locator 126 (location feature) and glued, such as with adhesive 128, in place as shown in FIG. 8 proximate to leg(s) 130.

The batteries are fitted in holders on the circuit board.

The top half of the receiver unit 18 casing are re-used for the remote unit. A base is screwed on from below using existing bosses in the top part.

The remote unit contains one test button (using on/off switch hole) and a 12V input connection.

In some embodiments, an alarm arrangement for causing an alarm signal to be emitted in response to a person being monitored when entering a water zone, the arrangement including: a transportable electronic transmitter unit (16), wherein the transportable electronic transmitter unit (16) has attachment means (100) for associating it with a user's body, and a housing (20) containing operatively connected electronic circuitry components, and having water activated electrical contacts (24, 26) outside the housing (20) for causing energization of the electronic circuitry when coming into contact with water so as to emit a chirp operative signal when such a person wearing the transmitter unit (16) enters into water in a water zone (10) being monitored; and an electronic receiver unit (18), wherein the receiver unit (18) includes a housing (36) containing operatively connected electronic circuitry components, and having water activated electrical contacts (54, 56) outside the housing (36) for causing energization of the electronic circuitry when coming into contact with water, and being adapted to detect any operative signal at a preselected frequency from the transmitter unit (16) when the transmitter unit (16) comes into contact with water in the water zone (10) being monitored, and the receiver unit (18) being adapted thereupon to emit a suitable alarm signal.

In further embodiments, the transmitter unit (16) includes an electronic circuit including operatively connected together connection means for connection to a battery (22), an electronic switch (28), a crystal stabilized oscillator (30), an amplifier (32), and a speaker (34).

In further embodiments, the transmitter unit (16) is adapted to emit a chirp operative signal in the 8 to 12 kHz frequency band.

In further embodiments, the receiving unit (18) includes an electronic circuit including operatively connected together connection means for connection to a battery (40), an electronic switch (52), a voltage regulator (42), a voltage comparator (44), a micro-processor (46), an active band pass filter (62), two amplifiers (48, 60), a phase lock loop (58), a microphone (64) and a speaker (50).

In further embodiments, the micro-processor (44) is configured to conduct an initial battery check routine in which the logic state of the voltage comparator (44) is monitored so as to establish whether the battery (40) is sufficiently charged and to cause an appropriate signal to be emitted by the speaker (50).

In further embodiments, the micro-processor (46) is configured to monitor the logic state of the electronic switch (52) to establish whether or not the switch (52) is closed.

In further embodiments, the electronic switch (52) of the receiver unit (18) is configured to close when the electrical contacts (54, 56) located outside of the housing (36) are bridged by way of water, and if not bridged by way of water in a predetermined period of time, to cause an appropriate signal to be emitted by the speaker (50).

In further embodiments, the micro-processor (46) is configured to monitor signals received by the microphone (64) and on reception of an operative signal having a preselected frequency to generate an appropriate signal which is amplified by the amplifier (46) and conveyed to the speaker (50) for emitting an alarm signal.

In further embodiments, the micro-processor (46) is adapted to calculate frequencies of all signals received and on reception of a pre-selected frequency to enter into the first monitoring mode whereby an appropriate signal is emitted by the speaker (50) indicating a sufficiently charged battery (40) and thereafter generating an appropriate signal which is amplified by the amplifier (46) and conveyed to the speaker (50), which generates an audible alarm signal.

In further embodiments, the housing (20) of the transmitter unit (16) includes a base (78), opposite side walls (80, 82), and a top (84), wherein the housing (20) defines a first chamber (86) adapted to contain the electronic circuitry components, and wherein the housing (20) defines a second chamber (88) adapted to removably locate the battery (22), the second chamber (88) being closable by way of a threaded nut (92) forming one of the electrical contacts (24) of the transmitter unit (16).

In further embodiments, the housing (36) of the receiver unit (18) includes a hollow cylindrical body (102, 106) closed at one side by a base (104) and closed at the other side by a lid (110), and wherein the lid (110) is removably and sealingly attached to the cylindrical body (102, 106) by a threaded ring (116).

In further embodiments, the housing (36) traps a volume of air once the lid (110) is attached, the air rendering the housing (36) to be floatable if placed in water in the water zone (10).

In further embodiments, the alarm arrangement is configured to not require the need for reliance on a reflected signal and increases the operational distance of the alarm arrangement significantly.

In further embodiments, the receiver unit houses an encoded radio receiver configured to trigger a remote alarm in the receiver unit housing (36).

In further embodiments, the alarm arrangement is configured to generate a signal of approximately 131 db and 1 μPa at 1 meter.

In further embodiments, the chirp operative signal is detectable to at least a 100 meter range.

In further embodiments, the alarm arrangement 14 may further comprise an ultrasonic transducer configured to audibly indicate when the battery is low.

Tests were conducted to evaluate the alarm arrangement of U.S. Pat. No. 6,476,721 (Diebold)

Evaluation of Existing Transmission Scheme and Recommendations:

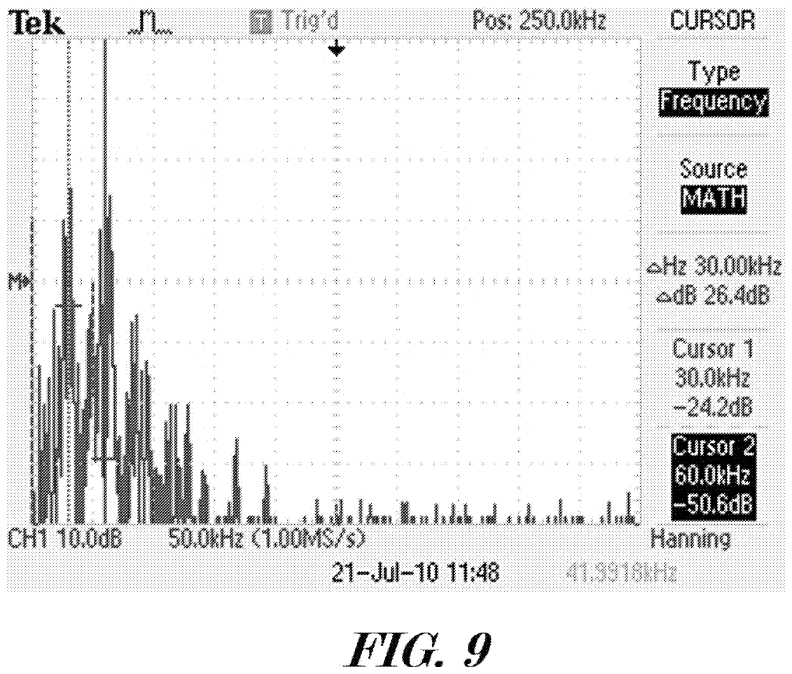

The existing transmitter unit emits a frequency hopped signal with the spectrum shown in FIG. 9. This was measured by a hydrophone at short range in an anechoic tank. The transmitted signal appears to hop between frequencies of 30 kHz and 60 kHz with a cycle of 0.5 ms. (It is hard to tell whether the weaker signal at 90 kHz is intentional or just the 3rd harmonic of the 30 kHz component generated by a square wave drive signal).

The overall emitted sound level is approximately 133 dB re 1 μPa at 1 meter (170 μW) but there is significant directivity in the device with the signal level dropping away off the axis of the transducer.

The spectral diversity given by the frequency hopping gives some immunity to multipath effects but the transmission scheme is still essentially based on narrowband signal detection. A typical swimming pool represents a severe multipath environment (due to strong reflections from the walls, bottom and surface) and the frequency selective fading characteristic of the channel will lead to potentially unreliable detection. It is thus recommended that broadband signal transmission, using spread spectrum techniques such as swept frequency (chirp) will increase immunity to multipath and also to narrowband noise sources.

Furthermore, the high directivity of the transmitter at these high frequencies means that if the transmitter is facing away from the receiver, it is dependent on a reflected path to reach the receiver which will obviously increase transmission loss. It would therefore be desirable to make the device less directional and approach an omnidirectional radiation pattern.

Finally, the relatively high frequencies used make the system more susceptible to attenuation by bubbles in the pool. In general, larger bubbles are required to attenuate lower frequency signals. For example, bubbles of approximately 20 μm diameter will generate a maximum attenuation at 90 kHz compared to ˜200 μm for 10 kHz. Bubbles of smaller diameter are not only more numerous but they take longer to disperse (float to the surface) after injection. Hence, although the processes of bubble formation may be varied, it is a general recommendation that lower frequency operation will reduce the incidence of bubble related attenuation problems.

Evaluation of Existing Transducer for Low Frequency Broadband Signal Transmission:

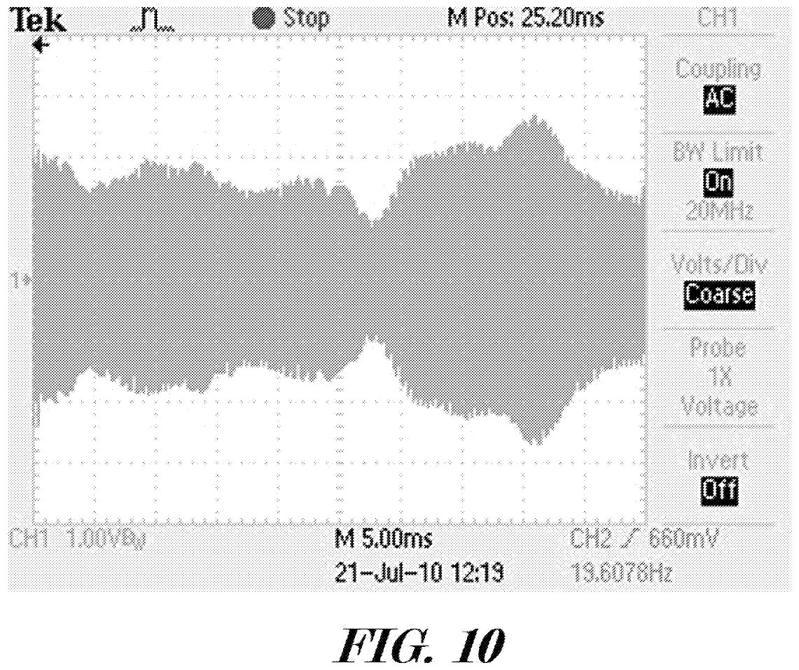

The transmitting transducer of U.S. Pat. No. 6,476,721 (Diebold) is based on a very low cost piezoelectric sounder bonded to the plastic casing. One of the units was modified to disconnect the existing drive electronics and attach an extension cable to the transducer. This enabled carrying out a transmitting frequency response measurement on the transducer as it would behave in the plastic housing. This revealed that the transducer had a relatively flat transmitting frequency response from about 6-100 kHz although there were numerous dips at particular frequencies, most likely due to reflections within the plastic structure and residual reflections within the tank. However, it was found that a there is a broad frequency band from approximately 8-12 kHz where the response is almost flat. FIG. 10 shows the envelope of a frequency sweep from 8-12 kHz.

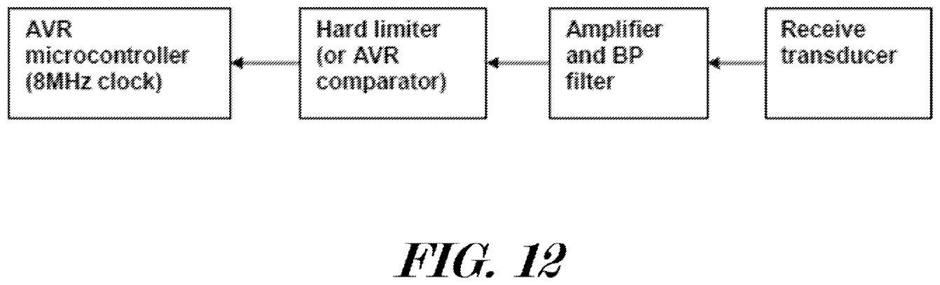

FIG. 12 shows how the response varies when the transducer is rotated by 90 degrees off axis. This suggests that the response is still reasonable at this angle whereas the high frequency response drops off more severely. Hence the overall angular coverage at this frequency would be much better than the existing system.

The mean transmitter sensitivity over this band was estimated at 113 dB re 1 μPa/V at 1 m. This means when driven from a 12V push pull driver stage (using the same battery as the existing design), the output source level would be 132 dB re 1 μPa at 1 meter. This is similar to the measured sound output of the existing design.

The receiver transducer of U.S. Pat. No. 6,476,721 (Diebold) is unsatisfactory for a number of reasons both mechanical and acoustic. Hence, in preferred embodiments, the speaker 34 may comprise a piezoelectric speaker having a cylindrical tube piezoceramic crystal 124 which is both more sensitive and easier to construct. The ceramic is housed in a bowl shaped protrusion at the bottom of the plastic casing with epoxy between the outer surface of the ceramic and the plastic and air inside the ceramic tube. This provides a two layer matching between the ceramic and the water and should be effective acoustically whilst avoiding any seal requirement.

The use of broadband linear frequency modulated signals (chirps) has proven very successful in underwater acoustic modem devices. Hence the transmitter unit 16 is modified to generate a repetitive linear sweep from 8-12 kHz over a period of 50 ms and the receiver performs a matched filter (correlation) to detect this waveform. This will provide excellent immunity to multipath effects in the pool and a spread spectrum processing gain of 23 dB. The correlation threshold may be optimized to achieve an acceptable false alarm rate, in addition to requiring multiple detections in a short time period to trigger the alarm (e.g. 3 detections in 200 ms).

The transmitter circuit includes a microcontroller to generate the chirp signal.

The alarm arrangement 14 includes the implementation of a matched filter detector within the power budget of the receiver unit. Assuming that the same battery pack is used (4×alkaline D cells), the unit must average 4.1 mW power consumption for a 3 year operating life. Similar receivers have been implemented in the past using low power microcontrollers of the Atmel AVR family and 1-bit (hardlimited) signal processing, shown in FIG. 12. This design is further optimized for power consumption by using newer, low voltage members of the AVR family. If necessary, reducing the duty cycle of the receiver will also be considered to reduce power consumption without significant increasing detection delay e.g. (receiver active for 250 ms and then asleep for 250 ms).

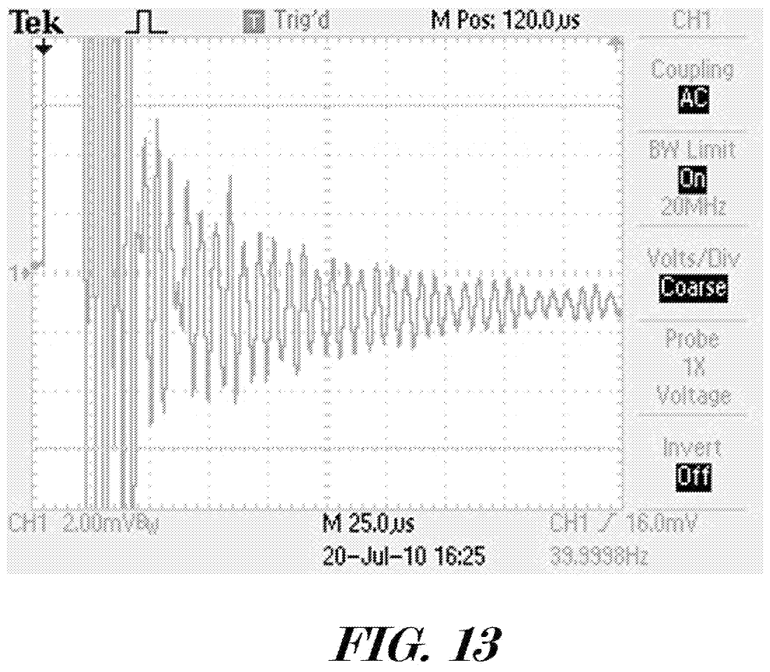

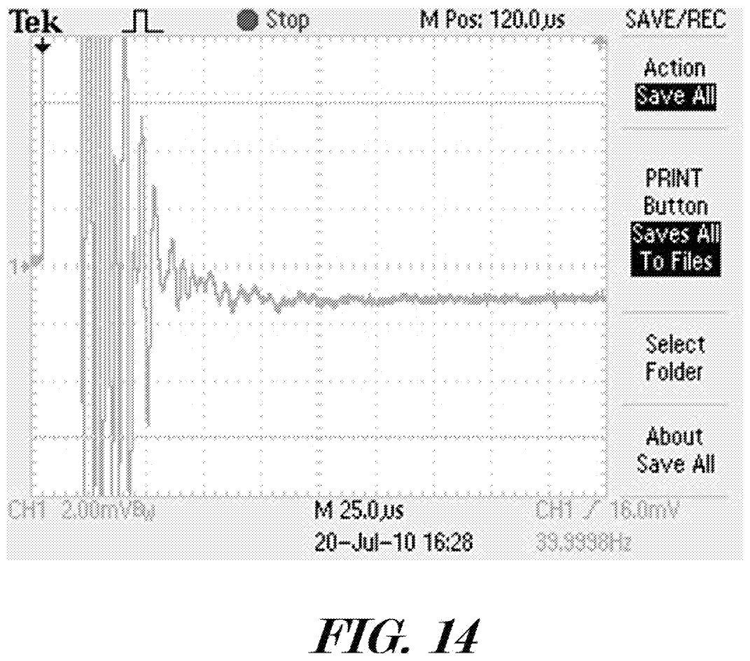

“Out of water” detection: To avoid the extra complexity of the capacitive sensor used in the existing design of U.S. Pat. No. 6,476,721 (Diebold), use is made of the receiver transducer to detect when the unit is submerged. If the transducer is excited with a pulse, it will tend to ring with a decay that is dependent on the damping of the transducer. If the transducer is in air, the oscillations are weakly damped and so the ringing will continue for a long period compared to when the transducer is in water and most of the energy of the oscillation escapes into the water. This is illustrated by FIGS. 13 and 14 which show the ringing effect on a transducer, based on the same ceramic tube used here, when in air and then in water. The transducer used in the present application is highly damped by the construction and the ringing of from the air backed unit and is even more obvious and easy to detect.

Simple circuitry is used to detect the envelope of this ringing when the transducer is periodically excited with a short pulse. The frequency at which this measurement is repeated will effect power consumption but it is expected that a compromise is made (e.g. checking every 10 s to see if the unit is still in the water). This approach avoids extra wiring and hardware associated with the capacitive sensor.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

1. An alarm arrangement for causing an alarm signal to be emitted in response to a person having a body being monitored when entering a water zone, the arrangement including:
a transportable electronic transmitter unit, wherein the transportable electronic transmitter unit has attachment means for associating it with the body of the person being monitored, and a housing containing operatively connected electronic circuitry components, and having water activated electrical contacts outside the housing for causing energization of the electronic circuitry when coming into contact with water so as to emit a chirp operative signal when such a person wearing the transmitter unit enters into water in a water zone being monitored; and
an electronic receiver unit, wherein the receiver unit includes a housing containing operatively connected electronic circuitry components, and having water activated electrical contacts outside the housing for causing energization of the electronic circuitry when coming into contact with water, and being adapted to detect any operative signal at a preselected frequency from the transmitter unit when the transmitter unit comes into contact with water in the water zone being monitored, and the receiver unit being adapted thereupon to emit a suitable alarm signal.

2. The alarm arrangement of claim 1, wherein the transmitter unit includes an electronic circuit including operatively connected together connection means for connection to a battery, an electronic switch, a crystal stabilized oscillator, an amplifier, and a speaker.

3. The alarm arrangement of claim 2, wherein the speaker comprises a piezoelectric speaker.

4. The alarm arrangement of claim 1, wherein the transmitter unit is operable to emit a chirp operative signal in the 8 to 12 kHz frequency band.

5. The alarm arrangement of claim 1, wherein the receiving unit includes an electronic circuit including operatively connected together connection means for connection to a battery, an electronic switch, a voltage regulator, a voltage comparator, a micro-processor, an active band pass filter, two amplifiers, a phase lock loop, a microphone, and a speaker.

6. The alarm arrangement of claim 5, wherein the micro-processor is configured to conduct an initial battery check routine in which a logic state of the voltage comparator is monitored so as to establish whether the battery is sufficiently charged and to cause an appropriate signal to be emitted by the speaker.

7. The alarm arrangement of claim 6, wherein the micro-processor is configured to monitor the logic state of the electronic switch to establish whether or not the switch is closed.

8. The alarm arrangement of claim 7, wherein the electronic switch of the receiver unit is configured to close when the electrical contacts located outside of the housing are bridged by way of water, and if not bridged by way of water in a predetermined period of time, to cause an appropriate signal to be emitted by the speaker.

9. The alarm arrangement of claim 8, wherein the micro-processor is configured to monitor signals received by the microphone and on reception of an operative signal having a preselected frequency to generate an appropriate signal which is amplified by the amplifier and conveyed to the speaker for emitting an alarm signal.

10. The alarm arrangement of claim 9, wherein the micro-processor is adapted to calculate frequencies of all signals received and on reception of a pre-selected frequency to enter into a first monitoring mode whereby an appropriate signal is emitted by the speaker indicating a sufficiently charged battery and thereafter generating an appropriate signal which is amplified by the amplifier and conveyed to the speaker, which generates an audible alarm signal.

11. The alarm arrangement of claim 1, wherein the housing of the transmitter unit includes a base, opposite side walls, and a top, wherein the housing defines a first chamber adapted to contain the electronic circuitry components, and wherein the housing defines a second chamber adapted to removably locate a battery, the second chamber being closable by way of a threaded nut forming one of the electrical contacts of the transmitter unit.

12. The alarm arrangement of claim 1, wherein the housing of the receiver unit-includes a hollow cylindrical body closed at one side by a base and closed at the other side by a lid, and wherein the lid is removably and sealingly attached to the cylindrical body by a threaded ring.

13. The alarm arrangement of claim 12, wherein the housing traps a volume of air once the lid is attached, the air rendering the housing to be floatable if placed in water in the water zone.

14. The alarm arrangement of claim 1, wherein the speaker comprises a piezoelectric speaker, and wherein the piezoelectric speaker comprises a cylindrical tube piezoceramic crystal.

15. The alarm arrangement of claim 14, wherein the alarm arrangement is configured to not require the need for reliance on a reflected signal and increases an operational distance of the alarm arrangement significantly.

16. The alarm arrangement of claim 1, wherein the receiver unit houses an encoded radio receiver configured to trigger a remote alarm in the receiver unit housing.

17. The alarm arrangement of claim 1, wherein the alarm arrangement is configured to generate a signal of approximately 131 db and 1 μPa at 1 meter.

18. The alarm arrangement of claim 1, wherein the chirp operative signal is detectable to at least a 100 meter range.

19. The alarm arrangement of claim 2, further comprising an ultrasonic transducer configured to audibly indicate when a battery is low.
